(19) United States
(12) Patent Application Publication
(10) Pub. No.: US 2004/0023193 A1
(43) Pub. Date: Feb. 5, 2004

(54) Partially prompted sentence-making system and method

(76) Inventors: Say Ling Wen, Taipei (TW); Zechary Chang, Taipei (TW); Pinky Ma, Beijing (CN)

Correspondence Address: JACOBSON HOLMAN PLLC, 400 SEVENTH STREET N.W., SUITE 600, WASHINGTON, DC, 20004, US

(21) Appl. No.: 10/211,371

(22) Filed: Aug. 5, 2002

(51) Int. Cl. G09B 19/00

(52) U.S. Cl. 434/167

(57) ABSTRACT

The partially prompted sentence-making system and method of the invention applies various prompted test types to enable a learner to master major syntactic components through repetitive practice during sentence-making training. The system enables a learner to achieve the goal of having good command of sentence making in a foreign language and further develop his/her proficiency in that foreign language.

### FIELD OF THE INVENTION

The invention relates to a computer-assisted sentence-making system and method in a foreign language. In particular, it is a kind of system and method that enables a learner to make sentences by mastering different syntactic components through a variety of partially prompted test types.

### BACKGROUND OF THE INVENTION

“Sentence-making” is important and requires training during the process of learning a foreign language. Conventional teaching in classes usually involves providing a learner with several commonly used and unchanged syntactic patterns to process sentence-making training with repeated sentence replication and replacement. Such practices only focus on getting a learner accustomed to syntactic structures. They neglect the practical application of individual components that constitute a sentence. Therefore, while making sentences, a learner can only obtain a general perspective without further knowledge of tense transformation, verbal characteristics etc. Besides, the contents and learning formats of traditional “duck-feeding” practices only provide a learner with a limited channel to learn sentence-making in a foreign language via a few commonly used samples. It leaves little room for a learner to think, and does not allow the learner to develop a habit of self-thinking. Consequently, it is rather difficult for a learner to make rational and comprehensive sentences in practical situations.

Recently, with advancing computer technology, a large range of application software for making sentences in foreign languages has been developed. In general, although most of these mark improvement over traditional teaching of sentence-making in a foreign language, they still focus on a general level of sentence-making as a whole without emphasizing individual syntactic components. For those beginners who have no ability to make a complete sentence independently, such general sentence-making is too difficult for them. As a result, for those people it is rather difficult to overcome the learning threshold in a short time.

In the long run, when a learner spends a tremendous amount of time and effort without coming to understand the spirit of sentence-making in a foreign language, it not only damages the learner's motivation for learning, but also undermines his/her confidence in learning sentence-making in a foreign language. Therefore, how to utilize advanced computer technology with compatible sentence-making modules, which allows a user to process training with various cycles of sentence making and repeatedly exercise all kinds of syntactic structures, is becoming an important R&D focus for learning software vendors.

### SUMMARY OF THE INVENTION

The object of the disclosed invention is to solve the above issues by providing a partially prompted sentence-making system and method. Its aim is to enable a learner to easily master major syntactic components through repetitive practice and be proficient in making sentences in a foreign language utilizing various partially prompted sentence-making modules.

In order to meet the above objectives, the invention proposes a system that contains a syntax database, a test determination module, a process and output module, an input acceptance module, and a results contrast module.

The invention includes the following steps: initiating the sentence making training and confirming a test determination module; retrieving a syntactic sample and displaying the output process module; starting the input process after the learner finishes the input process; finally, completing the sentence making training for the learner.

The detailed content and technology of the invention is depicted by the following figures and descriptions.

### BRIEF DESCRIPTION OF THE DRAWINGS

FIG. 1 is a block diagram of the invention.

FIG. 2 is an operation flowchart of the invention.

FIG. 3 is a prompt flowchart of the invention.

FIG. 4-a is an embodiment of the invention.

FIG. 4-b is an embodiment of the invention.

FIG. 4-c is an embodiment of the invention.

### DESCRIPTION OF THE PREFERRED EMBODIMENT

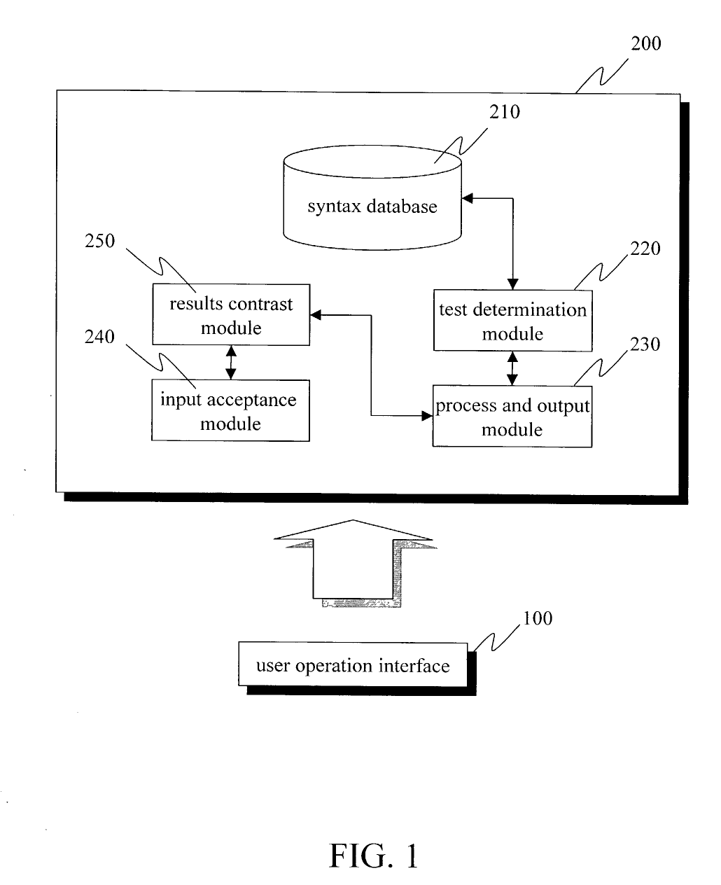

The invention is a partially prompted sentence-making system and method. FIG. 1 illustrates the framework of the disclosed system and method. Details are provided as follows:

(1) A syntax database 210 stores all syntactic samples of test contents for sentence-making practice. Each syntactic sample consists of: original syntactic contents (including both lettering and speech sounds), contextual contents (including both lettering and speech sounds), and relevant prompted syntactic contents. In particular, the relevant prompted syntactic contents are segmental contents of original syntactic contents (such as segmental pictures, paragraph translations, and candidate phrases, etc.), and are composed of a variety of media (such as lettering, speech sounds, pictures and animations).

The relevant prompted syntactic contents mainly provide required test contents and types based on various test modules in order to enable a learner to master the major syntactic components during the sentence-making training process.

(2) A test determination module 220 randomly retrieves a syntactic sample from the syntax database 210 and determines a test type after the syntactic sample is generated from the syntax database 210. The test types at least consist of: a reorganized sentence-making test type, a Q&A sentence-making test type, and a sorted Q&A test type. The reorganized sentence-making test type allows a learner to reorganize a randomly arranged sentence based on partial prompting of the paragraph content. The Q&A sentence-making test type allows a learner to select an answer through partial prompting of a picture or a paragraph translation of the content. The sorted Q&A test type allows a learner to select a proper answer from a plurality of selected candidate phrases based on prompting of syntactic context and partial pictures.

(3) A process and output module 230 processes sentence dividing and rearranging of a retrieved syntactic sample based on a test type determined by the test determination module 220, then generates and outputs the restructured sentence. The sentence dividing and rearranging process at least consists of: temporarily storing original syntactic contents (in order to contrast with the content inputted by a learner), dividing the original syntactic contents (generating a plurality of syntactic guidance units that cannot be altered by a learner and a plurality of syntactic composition units that can be altered by a learner), and randomly arranging the divided sentence.

(4) An input acceptance module 240 enables a learner to operate the input process through a user operation interfere 100. The ways for a learner to operate the process including key-in, drag and point to choose, or vocal input.

(5) A results contrast module 250 contrasts inputted data by a learner with the previous original sentence content temporarily stored in the memory, and then outputs the contrast result to the learner. The system is able to instantly correct the learner and determine whether similar and advanced syntactic exercises need to be provided to the learner if s/he inputs an incorrect answer. This makes the learner more familiar with the same kind of syntactic contents through repetitive practice.

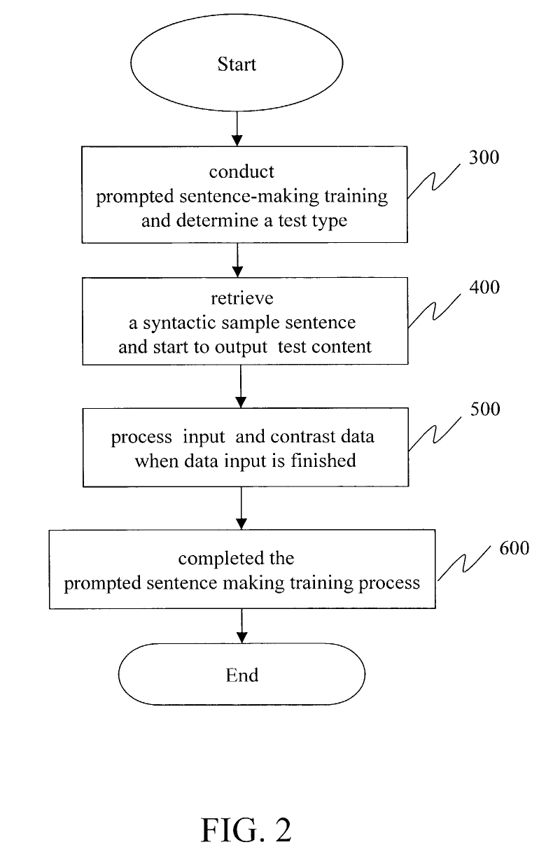

FIG. 2 illustrates the operational flowchart of the disclosed system and method as follows:

When a learner begins the sentence making training, the test determination module 200 determines a test type (step 300). It retrieves a syntactic sample from the syntax database 210 after a test type is determined (a reorganized sentence-making test type, a Q&A sentence-making test type, or a sorted Q&A test type) and outputs test content for the learner (step 400). At this stage, the learner starts to input data based on questions and prompting provided, and the system automatically determines whether the learner has completed data input and process data contrasts after data input is completed (step 500). The process flow of the prompted sentence-making training is completed when the system finishes data contrasts and outputs the result to the learner (step 600).

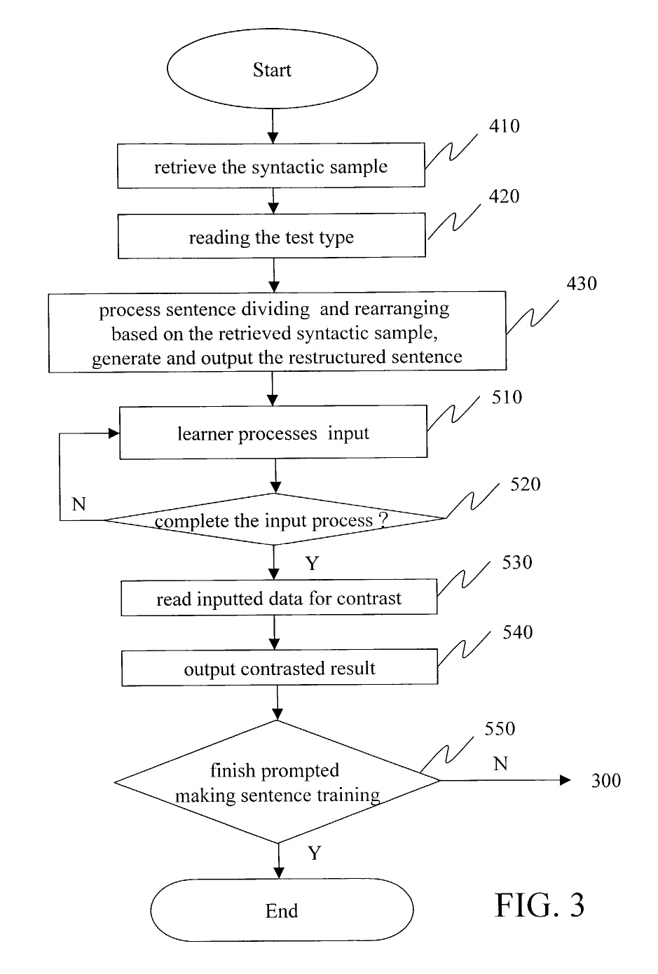

Prompting sentence making is the critical part of the invention. FIG. 3 shows a flowchart representation of the partially prompted sentence-making system and method.

First of all, the process and output module 230 retrieves a syntactic sample for testing (step 410) and reads a test type (step 420). Based on the test type, the process and output module 230 then processes sentence dividing and rearranging (including temporarily storing original syntactic contents, dividing the original syntactic contents and randomly arranging the divided sentence), generates and outputs a restructured sentence (including a plurality of syntactic guidance units that cannot be altered by a learner and a plurality of syntactic composition units that can be altered by a learner) (step 430). At this stage, the learner is able to start the input process through a user operation interface 100 to key in, drag and point to choose, or vocally input to operate the input process of accessible syntactic composition units (step 510). At the same time, when the learner processes data input, the system automatically verifies if the input process has been completed (step 520). If NOT, the system waits (step 510) and allows the learner continue to inputting data; otherwise, the system continues onto the following step: instantly contrasting the learner's input data with the original syntactic content, which is temporarily retrieved and stored in the memory (step 530). After data contrasting, the system outputs the result to the learner (step 540). Thus completes one cycle of the sentence making training. The system then asks the learner whether or not to continue another prompted sentence making training (step 550). If the learner wishes to carry on, the system goes back to the process flow of step 300 and restarts another prompted sentence making exercise; otherwise, the system terminates the flow and completes the learner's prompted sentence making practice.

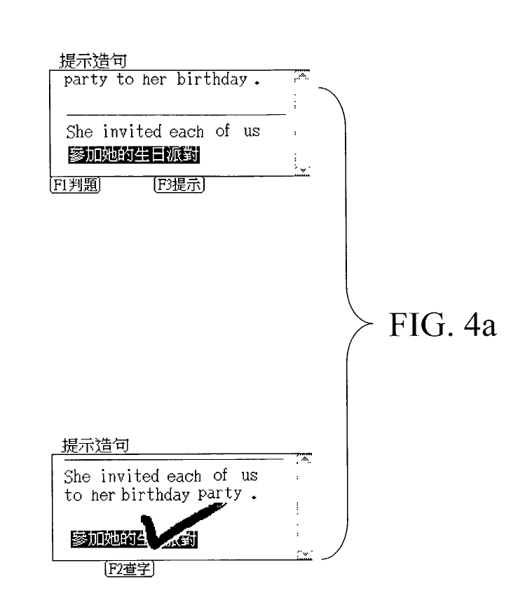

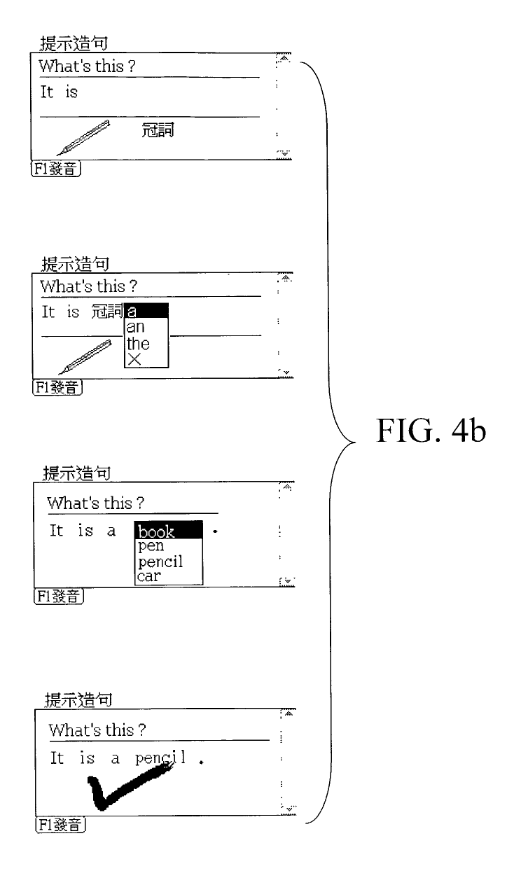

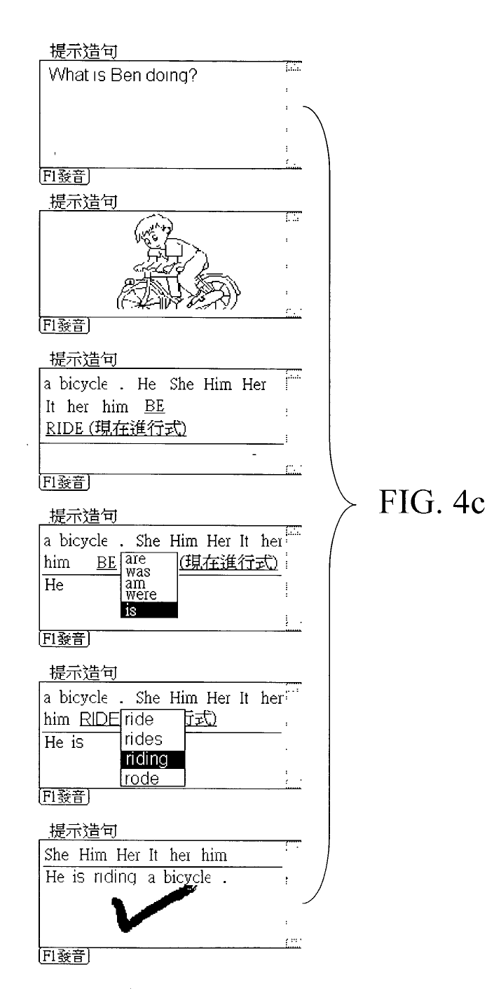

With reference to FIGS. 4-a, 4-b, and 4-c, three respective test types are represented as follows in order to demonstrate the feasibility of the invention.

First of all, FIG. 4-a is an example of a reorganized sentence-making test type of the disclosed invention. Under this module, the system divides the original syntactic content into a reorganized sentence in advance. A learner only needs to follow a prompted partial translation (such as: “ [symbol] ”) and assemble the syntactic composition units (i.e. “party”, “to”, “her”, and “birthday”) into the appropriate series sorted after the syntactic guidance unit (i.e. “she invited each of us”) to complete the answer. The system then contrasts the learner's answer with the original syntactic content, which is temporarily retrieved and stored in the memory, and after data contrast, the system outputs the result to the learner for his/her reference. Thus completes one cycle of the prompted sentence-making training process.

FIG. 4-b is an example for the Q&A sentence-making test type of the disclosed invention. A learner needs to answer in the syntactic composition unit after the syntactic guidance unit, according to a contextual content, a partial figure and a partial translation prompted by the system. For example, a contextual content sample in FIG. 4-b shows “What's this?” together with a partial figure and a partial translation prompted by the system. Under such a situation, the learner only needs to pick the appropriate syntactic composition units (such as “a” and “pencil”) after the syntactic guidance unit “It is” as a complete answer. The system then contrasts the answers of the learner and of the system and outputs a contrast result for the learner's reference to complete one cycle of prompted sentence-making training.

Finally, FIG. 4-c is an example of the sorted Q&A test type. Again, the system firstly provides a learner with content and a partial figure as prompting. The learner then conducts a selection input process through a reorganized sentence provided by the system such as “a”, “bicycle”, “He”, “She”, “Him”, “Her”, “It”, “her”, “him”, “BE” and “RIDE (present continuous tense)”. After the learner finishes answering, the system then contrasts the answers of the learner and of the system and outputs a contrast result for the learner's reference to complete one cycle of prompted sentence-making training.

### ACHIEVEMENTS OF THE INVENTION

The invention of a partially prompted sentence-making system generates different test types through computer assisted operation based on critical individual units in different syntactic elements. It enables a learner to learn from and be proficient in all-possible key syntactic types, tenses, and phrases in making sentences in a foreign language in a relatively short period. A learner can also utilize the diversified computer-assisted training for further enhancing his/her fluency in making sentences by using the minimum amount of time to achieve the maximum learning effect. Sentence-making training in a foreign language with computer assistance can minimize the embarrassment of face-to-face interaction between a teacher and a learner, and can follow a learner's inclinations to adjust the learning environment and progress pace.

An invention in the form of a partially prompted sentence-making system and method is disclosed herein. This and its variations, which will be understood by those skilled in the art, are within the intended scope of the invention as claimed below. As previously stated, detailed embodiments of the invention are disclosed herein; however, it is to be understood that the disclosed embodiments are merely exemplary of the invention that may be embodied in various forms.

What is claimed is:

1. A partially prompted sentence-making system that employs various prompting content segments and test types on the critical components of the training syntax to develop a learner's capability to master and apply syntactic structures of a foreign language in making sentences, the system comprising:
a syntax database, to store at least one syntactic sample for generating tests for sentence making exercises;
a test determination module, to retrieve the syntactic sample from the syntax database and determine a test type of the syntactic sample;
a process and output module, to proceed a sentence divided and rearranged process of the retrieved syntactic sample based on the determined test type, generates and outputs the restructured sentence;
an input acceptance module, to accept a learner to operate an input process through a user operation interfere; and
a results contrast module, to instantly contrast inputted data by a learner with the original sentence content, and output the contrast result to the learner.

2. The system as recited in claim 1, wherein the syntactic sample consists of an original syntactic content, a contextual content and a relevant prompted syntactic content.

3. The system as recited in claim 2, wherein the types of the relevant prompted syntactic content further include lettering, speech sounds, pictures and animations.

4. The system as recited in claim 2, wherein the relevant prompted syntactic content further consists of plurality of related segmental pictures, paragraphic translations, and candidate phrases of the original syntactic content.

5. The system as recited in claim 1, wherein the test type consists of a reorganized sentence making test type, a Q&A sentence making test type, and a sorted Q&A test type.

6. The system as recited in claim 1, wherein the sentence divided and rearranged process at least consists of: temporarily storing original syntactic contents, dividing the original syntactic contents and randomly arranging the divided sentence.

7. The system as recited in claim 1, wherein the restructured sentence consists of plurality of syntactic guidance units that can not be operated by a learner and plurality of syntactic composition units that can be operated by a learner.

8. A partially prompted sentence making method that employs various prompting content segments and test types on the critical components of the training syntax to develop a learner's capability to master and apply syntactic structures of a foreign language in making sentences, the method comprising the following steps:
conducting prompted sentence making training and determining a test type;
retrieving a syntactic sample sentence and starting to output test content;
proceeding input and contrasting inputted data; and
completing the prompted sentence making training process.

9. The method as recited in claim 8, wherein the test type consists of a reorganized sentence-making test type, a Q&A sentence-making test type, and a sorted Q&A test type.

10. The method as recited in claim 8, wherein the syntactic sample consists of an original syntactic content, a contextual content and a relevant prompted syntactic content.

11. The method as recited in claim 10, wherein the types of the relevant prompted syntactic content further include lettering, speech sounds, pictures and animations.

12. The method as recited in claim 10, wherein the relevant prompted syntactic content further consists of plurality of related segmental pictures, paragraphic translations, and candidate phrases of the original syntactic content.

13. The method as recited in claim 8, wherein the steps of retrieving a syntactic sample sentence and starting to output a test content consists of the following steps retrieving the syntactic sample content;
reading the test type; and
proceeding sentence dividing and rearranging based on the retrieved syntactic sample, generating and outputting the restructured sentence.

14. The method as recited in claim 13, wherein the sentence divided and rearranged process at least consists of: temporarily storing the original syntactic content, dividing the original syntactic content and randomly arranging the divided sentence.

15. The method as recited in claim 13, wherein the restructured sentence consists of plurality of syntactic guidance units that can not be operated by a learner and plurality of syntactic composition units that can be operated by a learner.
